(19) United States
(12) Patent Application Publication
(10) Pub. No.: US 2015/0287120 A1
(43) Pub. Date: Oct. 8, 2015

(54) MERCHANT MENU SUGGESTIONS BASED ON USER LOCATION AND FOOD PREFERENCES

(71) Applicant: EBAY INC., San Jose, CA (US)

(72) Inventor: Justin D. Davidson, San Jose, CA (US)

(21) Appl. No.: 14/247,017

(22) Filed: Apr. 7, 2014

(51) Int. Cl. G06Q 30/06; G06F 17/30

(52) U.S. Cl. CPC G06Q 30/0631; G06F 17/3053

(57) ABSTRACT

There is provided systems and method for merchant menu suggestions based on user location and food preferences. A user may establish preferences for certain types of food items, food descriptions, and/or types of ingredients. Using these preferences a merchant menu provider may search for merchants offering food items matching the preferences that are in proximity to the user. As the user selects merchants nearby from the list, information on the merchant's location and the menu items offered by the merchant may be accessed by the user, including prices, nutritional information, and directions to the merchant. If the user is with another user that also have food preferences, the list of nearby merchants may be refined with the second user's food preferences. Additionally, the user may view rating information for the merchant and the merchant's food items matching their preferences.

### TECHNICAL FIELD

Example embodiments of the present application relate generally to merchant menu suggestions based on user location and food preferences, and more specifically to providing a user with information about nearby merchants that offer food items matching the user's food preferences.

### BACKGROUND

Merchants offering food items, such as restaurants, food trucks, concessions, etc., may offer various food items for sale through a menu of available items. Users who know of nearby merchants and the food items offered by the merchants may make selections of the desired eating choices from these merchants. However, where a merchant may be at a new location or have recently opened, the user is not aware of offered food items by the merchant. Moreover, the merchant's methods to contact users include advertising, which may be costly to the merchant, or word of mouth/online reviews, which may be slow to accrue for new merchants or inaccurate. Additionally, for users in new or unfamiliar locations, the user's methods to find merchants is to ask people familiar with the area or perform background checks and searches. Thus, both of these methods may provide incomplete information that may be detrimental to a user that desires a particular food item, type of food, or has specific food preparation instructions based on a diet, allergy, or religious reason.

### BRIEF DESCRIPTION OF THE DRAWINGS

FIG. 1 is a block diagram of a networked system suitable for implementing the process described herein, according to an embodiment;

FIG. 2 is an exemplary user device displaying received information on nearby merchants offering food items matching a user's food preferences, according to an embodiment;

FIG. 3 is a flowchart of an exemplary process for merchant menu suggestions based on user location and food preferences, according to an embodiment; and

FIG. 4 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide merchant menu suggestions based on user location and food preferences. Systems suitable for practicing methods of the present disclosure are also provided.

In various embodiments, a user may utilize a user device to receive merchant menu suggestions based on the user's location and food preferences. The user device may receive the menu suggestions from a service provider server, such as a payment provider server or other service provider with information of the user's food preferences. The service provider server may receive and/or determine the user's food preferences from user input, based on past user purchases, and/or based on a user search history for food and/or food merchants. The food preferences may be favorite foods of the user and may be based on a food's name, description, and/or ingredients. Once the user's food preferences have been collected, the server provider server can access the food preferences and determine if merchants nearby a location of the user offer at least one food item that matches the user's food preferences. The user's location information may be received from the user device, such as through a location module of the user device (e.g., a GPS module/system). In other embodiments, the user's location may be determined from user input or through connections of the user device (e.g., to a cell phone service provider, a wireless network connection, etc.). The closest matching nearby merchant may be communicated to the user or a list of nearby merchants that match the food preferences may be provided to the user.

If the user selects a merchant matching the food preferences from an application interface on the user device, merchant information may be provided to the user. The merchant information may include at least information about the merchant's location (e.g., address, a map to the merchant's location, and/or directions to the merchant's location) and the merchant's menu information for the food item that matches the food preferences (e.g., name, price, description, ingredients, etc.) If available, nutritional information may also be provided for the food item. Other information about the merchant and/or the specific food item may be provided, such as reviews and/or ratings. The reviews and ratings may be taken from another online source (e.g., a website dedicated to review food and/or restaurants, a newspaper or magazine review available online, and blog or social media postings) or may be determined from user input after the user dines at the merchant location. Rating information may be provided for both the merchant and for the specific food item that matches the user's food preferences. For example, users may have a business satisfaction rating corresponding to service, price, etc., for the merchant. Additionally, users may have specific ratings to the quality, taste, ingredients, etc., for the specific food item. The service provider may determine if the user travels to the merchant location and purchases food based on a location of the user and/or payment receipts with the merchant. If the user has done so, the service provider may query the user for reviews of the merchant and/or food items purchased. Where more than one merchant is determined for the user, the merchants may be compared and contrasted using merchant reviews, prices for the specific food item(s), and/or food's reviews.

Additionally, the user may travel with one or more other users that also have food preferences. Thus, food preference information for the other users may be accessed as well. This food preference information may be used to refine the original search or generate a new search for merchants having food items that match both the original user's food preferences and the food preferences for the other users in the group. In certain embodiments, only merchants offering food items for both the original user and the other users will be presented. However, all merchants matching any of the users may be provided in other embodiments even if the merchants do not match the food preferences of some of the users.

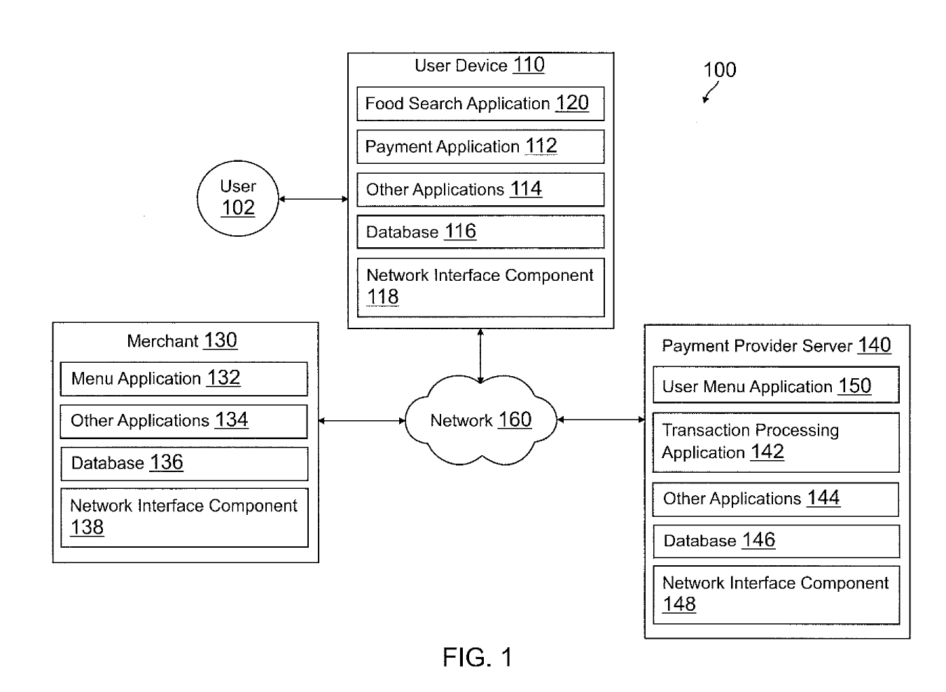

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant 130, and a payment provider server 140 in communication over a network 160. Payment provider server 140 may access food preferences for user 102, such as a consumer. Payment provider server 140 may match the food preference information to merchant 130 based on food items offered by merchant 130 (e.g., a food menu that merchant 130 offers for sale) and location information for user 102. User 102 may utilize user device 110 to receive information about merchant 130, including menu information and/or location information.

User device 110, merchant 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication with merchant 130 and/or payment provider server 140. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a food search application 120, a payment application 112, other applications 114, a database 116, and a network interface component 118. Food search application 120, payment application 112 and other applications 114 may correspond to processes, procedures, and/or applications executable by a hardware processor, for example, a software program. In other embodiments, user device 110 may include additional or different software as required.

Food search application 120 may correspond to an application that provides nearby merchants having food items that match user 102's food preferences. Thus, food search application 120 may provide an interface enabling user 102 to view information received from merchant 130 and/or payment provider server 140. In this regard, user device 110 may receive information about merchant 130 from payment provider server 140 after payment provider server matches merchant 130 to user 102 based on a location of user 102 and food preferences of user 102, as will be explained in more detail herein. Food preferences may be determined for user 102 based on entered information for user 102 through food search application 120 (e.g., through setting food preferences and/or searches for food types). Additionally, payment provider server 140 may determine the food preferences through past behaviors of user 102, as will be explained in more detail herein.

Food search application 120 may display the information to user 102 as a name and/or list of names of merchants nearby user 102. Merchant 130 may offer a food item or food type that matches the food preferences and therefore food search application 120 may also display the food item or type matching the food preferences (e.g., tacos or Mexican food depending on the information and/or level of specificity in the food preferences). If user 102 selects a merchant or wishes to view more information for the merchant, food search application 120 may request the information from merchant 130 and/or payment provider server 140. Additionally information may correspond to a menu for merchant 130 (e.g., offered food items, prices, descriptions, ingredients, etc.), location and/or direction information for merchant 130, nutritional information for merchant 130, or other available information. Thus, food search application 120 may include a mapping function or may include processes to map to a location of merchant 130 using another mapping application of user device 110.

In addition to information for a single merchant, food search application 120 may receive information for a plurality of merchants matching the food preferences of user 102. For example, in certain embodiments, merchant 130 may be provided to user 102 through food search application 120 as being the highest rated, most similar, or best rated food item matching the food preferences of user 102. However, in other embodiments, all merchants matching the food preferences in proximity to user 102 may be displayed to user 102 through an interface of food search application 120. User 102 may additionally use food search application 120 to determine the proximity distance used to search for merchants, such as a radius extension from user 102 (e.g., 3 miles from user 102), an amount of driving, a time for driving, and/or expected traffic conditions during driving. Thus, user 102 may define and/or refine the distance from user 102 used to search for merchants. Food search application 120 may also transmit location information for user 102 to payment provider server 140. The location information may be determined through a location module of user device 110, such as a GPS module. However, in other embodiments, payment provider server 140 may determine the location information for user 102 based on an IP address of user 102, a network connection of user 102, etc.

Food search application 120 may provide reviews and/or rating information for merchant 130 and other merchants provided to user 102. The reviews and/or rating information may include online reviews from another source (e.g., a reviewing website, newspaper, magazine, etc., or scraped from a blog, microblog, and/or social media post). In other embodiments, payment provider server 140 may collect reviews after a user eats at merchant 130 and provide those reviews to user 102. The reviews may include text reviews, comparative rankings, and/or numbered reviews (e.g., a number of stars). The reviews may correspond generally to the business and a satisfaction other users have had with the business, such as service, price, etc. Additionally, the reviews may also be item specific and may be for items matching the food preferences of user 102. For example, reviews and/or rating based on the food item's quality, taste, ingredients, price, etc. may be provided to user 102 through food search application 120. The quantity of reviews of the matched food item may also affect the rating/ranking of the matched food item. Thus, if user 102's food preferences match a hamburger, and merchant 130 offers a hamburger with 100 reviews, merchant 130 inform user 102 of the number of reviews and may rank merchant 130 over another merchant offering a hamburger with only 20 reviews. The quality of the reviewer may also have an effect on the ratings and/or rankings. Thus, if a reviewer is consistently noted as helpful, is a known or trusted food critic, and/or has an otherwise verified account, the reviewers comments, ratings, etc., with respect to merchant 130 may be more prominently displayed or may have an effect on the ranking of merchant 130.

In various embodiments, user 102 may travel with other users that also have food preferences. User 102 may enter the other user's food preferences through food search application 120 to refine a previous search or initiate a new search. Additionally, if the other user's food preferences are stored with payment provider server 140, an identifier for the other user may be provided through food search application 120 enabling payment provider server 140 to recall those food preferences (e.g., a user name and/or user account identifier). In certain embodiments, if user 102 and the other user are in close proximity and already associated (e.g., checked-in to a location together, associated through user account services, etc.), payment provider server 140 may automatically search for merchants matching the food preferences of user 102 and the other user(s).

If user 102 travels to merchant 130 and purchases food, payment provider server 140 may request a review for merchant 130 and/or the purchased food items. Thus, food search application 120 may be utilized to request and/or enter reviews for merchant 130 and/or the food item. User 102 may actively bring up a review page and submit the review and the name of merchant 130. Food search application 120 may also determine user 102 visited merchant 130 through a location module of user device 110, such as a GPS module, and request the review from user 102. Additionally, payment provider server 140 may determine user 102 visited merchant 130 through available information submitted to payment provider server 140 and request the review from user 102 through food search application 120, as will be explained in more detail herein.

Payment application 112 may be used, for example, to provide a convenient interface to permit user 102 to select payment options and provide payment for items (e.g. goods and/or services). For example, payment application 112 may be implemented as an application having a user interface enabling the user to enter payment options for storage by user device 110, provide payment on checkout of an item with merchant 130, and complete a transaction for the item with merchant 130 and/or payment provider server 140. In certain embodiments, payment application 112 may correspond more generally to a web browser configured to view information available over the Internet or access a website corresponding to a payment provider. Payment application 112 may utilize user financial information, such as a credit card, bank account, or other financial account. Additionally, payment application 112 may provide payment for items using a user account with the payment provider, such as payment provider server 140. Payment application 112 may include cross-linking, allowing user 102 to identify a user account through an identifier for a separate user account (e.g. identifying a user account through a debit card account number and vice versa). Payment application 112 may further include options to store transaction histories for purchased items, such as receipts, for later use. Thus, payment application 112 provides an interface enabling user 102 to provide proof of purchase of an item to a merchant.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 140, or other types of applications. Other applications 114 may also include email, texting, voice and IM applications that allow a user to send and receive emails, calls, texts, and other notifications through network 140. In various embodiments, other applications 114 may include financial applications, such as banking, online payments, money transfer, or other applications associated with payment provider server 140. Additionally, other application may include browser applications, social media applications, and/or mapping/check-in applications where not provided by one or more of food search application 120 and payment application 112. Other applications 114 may contain other software programs, executable by a processor, including a graphical user interface (GUI) configured to provide an interface to the user.

User device 110 may further include database 116 which may include, for example, identifiers such as operating system registry entries, cookies associated with food search application 120, payment application 112, and/or other applications 114, identifiers associated with hardware of user device 110, or other appropriate identifiers, such as identifiers used for payment/user/device authentication or identification. In one embodiment, identifiers in database 116 may be used by user device 110, merchant 130, and/or payment provider server 140, to associate user device 110 with a particular account maintained by payment provider server 140. Database may include information for food search application 120 including food preference information, merchant information (e.g., menu, location, review/ranking, etc.), and/or merchant location information. Database 116 may also store user merchant information, including an identifier for merchant 130. Database 116 may include transaction histories usable to present proof of purchase of food items to merchant 130 and/or payment provider server 140.

Database 116 may include information used by payment application 112, for example, user personal information (e.g. a name, social security number, user financial information, or other identifying information), a user account identifier (e.g. user account identifier is at least one of a user identifier, a user credit or debit card number, a user account name, and a user account number), and/or a user device identifier. In various embodiments, database 116 may include online account access information.

In various embodiments, user device 110 includes at least one network interface component 118 adapted to communicate with merchant 130 and/or payment provider server 140. Network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices. In various embodiments, network interface component 118 may include a communication module for short range communications with merchant 130 including microwave, radio frequency, infrared, Bluetooth, and near field communication devices.

Merchant 130 may correspond, for example, to a merchant or seller offering various food items for sale to user 102 through a merchant location. Generally, merchant 130 may be maintained by anyone or any entity that receives money in exchange for food, drinks, or other consumable, which includes restaurants, food trucks, concession stands, etc. In this regard, merchant 130 may include processing applications, which may be configured to interact with user device 110 and/or payment provider server 140 to facilitate the sale of food items including completion of payment requests for the food items.

Merchant 130 may be implemented using any appropriate hardware and software configured for wired and/or wireless communication with user device 110 and/or payment provider server 140. For example, in one embodiment, merchant 130 may be implemented as a single or networked personal computer (PC), a smart phone, personal digital assistant (PDA), laptop computer, and/or other types of computing devices at a merchant location capable of transmitting and/or receiving data. In other embodiments, merchant 130 may correspond to a networked server for a plurality of merchant locations, such as a chain restaurants server and/or online website. Although only one merchant is shown, a plurality of different merchants may be utilized.

Merchant 130 includes a menu application 132, other applications 134, a database 136, and a network interface component 138. Menu application 132 and other applications 134 may correspond to processes, procedures, and/or applications executable by a hardware processor, for example, a software program. In other embodiments, merchant 130 may include additional or different software as required.

Menu application 132 may be configured to provide menu information for merchant 130. In this regard, menu application 132 may provide information on available food items with merchant 130 (i.e., at least one merchant location corresponding to merchant 130) and/or other information for the available food items. Other information may include prices, descriptions, ingredients, and/or nutritional information for the food items. Menu application 132 may be utilized by a service provider, such as payment provider server 140, to associate merchant 130 with user 102 based on food preferences of user 102. Additionally, menu application 132 may include information for the location(s) of merchant 130, such as an address, map, and/or directions, and may include available review information submitted or collected by merchant 130.

In various embodiments, merchant 130 includes other applications 134 as may be desired in particular embodiments to provide features to merchant 130. For example, other applications 134 may include security applications for implementing device/server-side security features, programmatic server applications for interfacing with appropriate application programming interfaces (APIs) over network 160, or other types of applications. Other applications 134 may contain software programs, executable by a processor, including a graphical user interface (GUI), configured to provide an interface to a user. In various embodiments, other applications 134 may include payment applications configured to interact with user device 110 and/or payment provider server 140 to complete payment for goods, such as food products available with merchant 130.

Additionally, merchant 130 includes database 136. Database 136 may include merchant menu and/or location information. After completing payment for food items, database 136 may include transaction history information. Database 136 may store other information relevant to merchant 130, including review, rating, customer information (e.g., customer loyalty sales, accounts, etc.), advertising, and/or discount information. Information in database 136 may be utilized by payment provider server 140 when presenting merchant 130 to user 102.

In various embodiments, merchant 130 includes at least one network interface component (NIC) 138 adapted to communicate with network 160 including user device 110 and/or payment provider server 140. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RE), and infrared (IR) communication devices. In various embodiments, network interface component 138 may include a communication module for short range communications with user device 110 including microwave, radio frequency, infrared, Bluetooth, and near field communication devices.

Payment provider server 140 may be maintained, for example, by an online payment service provider, which may provide payment services to user 102. In this regard, payment provider server 140 includes one or more processing applications, which may provide payment for items between user device 110 and merchant 130. In one example, payment provider server 140 may be provided by PayPal®, Inc. of San Jose, Calif., USA. However, in other embodiments, payment provider server 140 may be maintained by or include a merchant, financial services provider, and/or other service provider, which may provide user account and payment service to user 102. Although payment provider server 140 is described as separate from a merchant and/or merchant server corresponding to merchant 130, it is understood that a merchant may include services offered by payment provider server 140.

Payment provider server 140 of FIG. 1 includes a user menu application 150, a transaction processing application 142, other applications 144, a database 146, and a network interface component 148. User menu application 150, transaction processing application 142, and other applications 144 may correspond to processes, procedures, and/or applications executable by a hardware processor, for example, a software program. In other embodiments, payment provider server 140 may include additional or different software as required.

User menu application 150 may correspond to an application configured to determine merchants in proximity to user 102 that match user 102's food preferences and provide information of those merchants to user device 110 for use by user 102. In this regard, user menu application 150 may access food preference information for user 102. Food preference information for user 102 may be stored with payment provider server 140, such as in database 146 of payment provider server 140. Food preference information may correspond to food items (e.g., tacos, hamburgers, etc.), food types (e.g., American, Chinese, etc.), food ingredients (including potential allergies, such as a peanut allergy, that may require avoided ingredients), descriptions (e.g., fresh, fast, etc.), or other preferences. Food preference information may further correspond to preparation techniques of food items (e.g., fried, baked, stewed, grilled, or more specific preparations, such as kosher, no MSG, etc.) and/or key seasonings used for the good items (e.g., garlic, chilies, citrus, etc.). Food preference information may map to other foods that user 102 has not previously tried. Thus, a preference for vegan dishes, stewed vegetarian chili with garlic and chili seasonings, and also grilled citrus vegetables may map to a preference for chana masala that is a spicy vegetarian dish with a citrus taste. Food preference information may be submitted to payment provider server 140 through food search application 120 of user device 110, as previously discussed. Additionally, user menu application 150 may determine food preference information from previous payment at food merchants by user 102. For example, if user 102 purchases pasta and/or Italian foods on multiple occasions, user menu application 150 may determine user 102 has an affinity for a particular type of pasta and/or Italian food in general. Additionally, food preference information may be scraped or taken from other online sources of user 102, such as social media posts, blogs/microblog, and/or ratings/reviews by user 102 posted online (e.g., through a food rating website, newspaper, and/or magazine). If user 102 submits reviews using food search application 120 after eating at a restaurant, those reviews may be further used to determine food preferences.

Once food preferences are accessed for user 102, user menu application 150 may determine merchants in proximity to user 102. The distance of the proximity to user 102 may be set by user 102 or a generalized distance may be utilized (e.g., 15 minutes, 3 miles, etc.). The location of user 102 may be received from user device 110, as previously discussed, or may be determined by user menu application 150 using information available for user 102 and/or user device 110 (e.g., a known address of user 102, an IP address for user device 110, network connections of user device 110). If merchant 130 matches the food preferences and location of user 102, merchant 130 may be transmitted to user 102. For example, the food preferences may comprise one or more favorite food items. Thus, if merchant 130 is in proximity to user 102, user menu application 150 may score food items offered by merchant 130 against the favorite food items based on a name, descriptions, and/or ingredients to determine if merchant 130 matches the food preferences of user 102.

In certain embodiments, only the merchant with the highest rating/ranking or with food items most similar to the user preferences of user 102 are provided to user 102 by user menu application 150. However, in other embodiments, a plurality of merchants offering food items matching the user preferences are provided to user 102. Additionally, user 102 may request another user's food preferences be used to refine or search with user 102's food preferences for merchants with food items. Thus, user menu application 150 may utilize more than one set of user preferences to determine one or more merchants in proximity to user 102 and transmit the merchant(s) to user 102.

Information for merchant 130 provided to user 102 may include a name for merchant 130 and the food items offered by merchant 130 that match the food preferences of user 102. Additionally, user 102 may receive additional information for merchant 130 from user menu application 150. As previously discussed, the additional information may include location information for merchant 130 and menu information for merchant 130. Menu information may include food items offered by merchant 130 (in addition to the food items matching the food preference of user 102), food prices, food descriptions, food ingredients, and/or food nutritional information. Moreover, user menu application 150 may provide reviews/ratings for merchant 130 and food items offered by merchant 130. User menu application 150 may pull the reviews from other online sources, such as online review sites, blogs, microblogs, social media posts, newspapers, and/or magazines.

Additionally, user menu application 150 may request reviews from users when the user eats at merchant 130. User menu application 150 may determine the user has visited and purchased items from merchant 130 based on a location of user 102, as previously discussed. However, user menu application 150 may also view transaction histories (e.g., receipts) for user 102 at merchant 130. For example, user 102 may utilize payment provider server 140 to pay for food items at merchant 130 and generate a transaction history of the food items and merchant 130. In other embodiments, payment provider server 140 may view transaction histories with other financial accounts, such as a banking account, for user 102 with merchant 130. Thus, utilizing this information, user menu application 150 may determine user 102 has purchased items at merchant 130 and should review merchant 130, including, in various embodiments, the specific purchased items.

Transaction processing application 142 may be configured to receive information from user device 110 and/or merchant 130 for processing and completion of financial transactions. Transaction processing application 142 may include one or more applications to process financial transaction information from user device 110 and/or merchant 130. Transaction processing application 142 may receive a payment request to complete a sale transaction for an item. Transaction processing application 142 may complete the sale transaction by providing payment to merchant 130. Transaction processing application 142 may receive a user payment account for user 102 with payment provider server 140 to provide payment to merchant 130. In other embodiments, transaction processing application 142 may receive user financial information, such as a payment card, bank account, gift card, or other financial information. Transaction processing application 142 may credit the payment to a payment account of merchant 130 with payment provider server 140 or to another financial account, such as a bank account. In other embodiments, transaction processing application 142 may provide transaction histories, including receipts, to user device 110 and/or merchant 130 in order to provide proof or purchase and complete the financial transaction.

In various embodiments, payment provider server 140 includes other applications 144 as may be desired in particular embodiments to provide features to payment provider server 140. For example, other applications 144 may include security applications for implementing server-side security features, programmatic server applications for interfacing with appropriate application programming interfaces (APIs) over network 160, or other types of applications. Other applications 144 may contain software programs, executable by a processor, including a graphical user interface (GUI), configured to provide an interface to a user.

Additionally, payment provider server 140 includes database 146. As previously discussed, user 102 and/or merchant 130 may establish one or more user accounts with payment provider server 140. User accounts in database 146 may include user/merchant information, such as name, address, birthdate, payment/funding information, additional user financial information, and/or other desired user data. User 102 and merchant 130 may link user accounts to user device 110 through a user, merchant, and/or device identifier. Thus, when an identifier is transmitted to payment provider server 140, e.g. from user device 110 and/or merchant 130, a user account belonging to user 102 and/or merchant 130 may be found. In other embodiments, user 102 and/or merchant 130 may not have previously established a user account and may provide other financial information to payment provider server 140 to complete financial transactions, as previously discussed.

In various embodiments, payment provider server 140 includes at least one network interface component (NIC) 148 adapted to communicate with network 160 including user device 110 and/or merchant 130. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

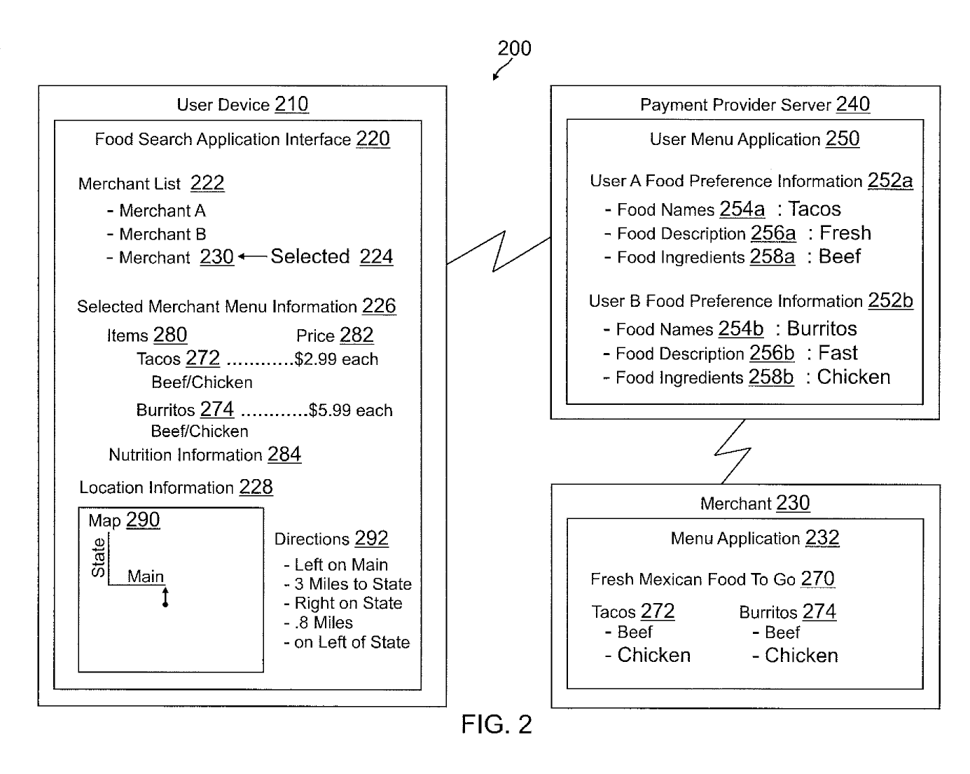

FIG. 2 is an exemplary user device displaying received information on nearby merchants offering food items matching a user's food preferences, according to an embodiment. Environment 200 includes a user device 210, a merchant 230, and a payment provider server 240 corresponding generally to user device 110, merchant 130, and payment provider server 140, respectively, of FIG. 1.

Payment provider server 240 may execute a user menu application 250 to access a user's food preferences. User menu application 250 may correspond generally to the processes and procedures of user menu application 150 of FIG. 1. Thus, user menu application 250 may access user A food preference information 252a for a user A and user B food preference information 252b for a user B. User A food preference information 252a includes food names 254a having “tacos,” food descriptions 256a having “fresh,” and food ingredients 258a having “beef.” Similarly, user B food preference information 252b includes food names 254b having “burritos,” food descriptions 256b having “fast,” and food ingredients 258b having “chicken.” User menu application 250 may access user A food preference information 252a and user B food preference information 252b from storage (e.g., a database of payment provider server 240) or may receive the information from user device 210.

If user A is alone (i.e., not with user B), user menu application 250 of payment provider server 240 may utilize only user A food preference information 252a to perform a search for merchants in proximity to user A and matching user A food preference information 252a. However, as previously discussed, user A may be associated with user B. In such embodiments, user menu application 250 may further utilize user B food preference information 252b to search for merchants in proximity to user A and user B that match user A food preference information 252a and user B food preference information 252b. In other embodiments, user B food preference information 252b may refine a search previously performed by user menu application 250 using user A food preference information 252a.

Thus, utilizing at least user A food preference information 252a and a location for user A (i.e. the user corresponding to user device 210), user menu application 250 may determine merchant 230 matches user A food preference information 252a and the location for user A and transmit information for merchant 230 to user device 210. As shown in environment 200, merchant 230 includes a menu application 232 with information about food items offered by merchant 230. Menu application 232 may correspond generally to the processes and procedures of menu application 132 of FIG. 1. Menu application 232 includes the description, “fresh Mexican food to go 270,” and menu items tacos 272 and burritos 274. Under menu items tacos 272 and burritos 274, ingredients of the menu items are provided.

User menu application 250 may match food names 254a of user A food preference information 252a to tacos 272 in menu application 232. Additionally, user menu application 250 may match food description 256a to the description, “fresh Mexican food to go 270,” and food ingredients 258a to the ingredients under tacos 272. Since user A has user A food preference information 252a that matches information in menu application 232, user menu application 250 may determine user A would potentially purchase food items from merchant 230. Thus, user menu application 250 may inform user A through user device 210 of merchant 230.

As previously discussed, if user A is with user B, then user B food preference information 252b may be further utilized to search or refine a search for merchants. As shown in environment 200, food names 254b in user B food preference information 252b may be matched to burritos 274 in menu application 232. Additionally, food description 256b matches the description, “fresh Mexican food to go 270,” and food ingredients 258b to the ingredients under burritos 274. Thus, if user A is with user B, user menu application 250 may further determine both user A and user B may purchase food items from merchant 230 and, therefore, provide information of merchant 230 to user A and user B through user device 210 (and/or through another user device of user B).

User menu application 250 may therefore transmit information to user device 210. The information may be displayed to user A through a food search application interface 220. Food search application interface 220 may correspond generally to the processes and procedures of food search application 120 of FIG. 1. Food search application interface displays a merchant list 222, selected merchant menu information 226, and location information 228 to user A. Merchant list 222 may correspond to a list of merchants matching the food preferences of user A and any other users with user A (e.g., user A food preference information 252a and user B food preference information 252b). Merchant list 222 includes a merchant A, a merchant B, and merchant 230. Thus, merchant 230 displayed in merchant list 222 may enable user A to select merchant 230 in merchant list 222 to view additional about merchant 230. Thus, in environment 200, merchant 230 is shown as selected 224. Selected 224 may correspond to a request to view additional information about merchant 230 by user A.

Since merchant 230 has been selected 224, merchant information for merchant 230 may be displayed under selected merchant menu information 226. Information under selected merchant menu information 226 includes items 280, price 282, and nutrition information 284. In other embodiments, different information may be displayed, including restaurant and/or food descriptions, ratings, and/or rankings. As shown under items 280 are tacos 272 for $2.99 each and having ingredients beef/chicken and burritos 274 for $5.99 each and having ingredients beef/chicken. Thus, user A may view food matches at merchant 230 for user A food preference information 252a and/or user B food preference information 252b. User A may then decide whether to visit merchant 230 to purchase food items. User A may also select nutrition information 284 to view further information about items 280 offered by merchant 230. In various embodiments, food search application interface 220 may further include a process to select food items for purchase from merchant 230 and pre-order the food items prior to arriving at merchant 230. Thus, food search application interface 220 may also include ordering and payment processes.

Food search application interface 220 further displays location information 228 to user A. Location information 228 includes map 290 and directions 292. Location information 228, in various embodiments, may include an address and a process to map to the address using another mapping application of user device 210. Location information may be pulled from merchant 230 and presented to user A.

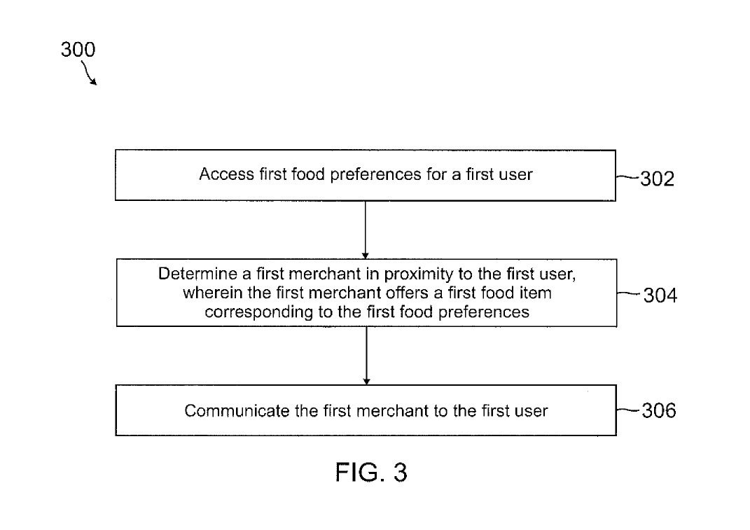

FIG. 3 is a flowchart of an exemplary process for merchant menu suggestions based on user location and food preferences, according to an embodiment. Note that one or more steps, processes, and methods described herein may be omitted, performed in a different sequence, or combined as desired or appropriate.

At step 302, first food preferences for a first user are accessed. The first food preferences may comprise favorite food items. At step 304, a first merchant in proximity to the first user is determined, wherein the first merchant offers a first food item corresponding to the first food preferences. The first merchant may be determined by matching the favorite food items against the first food item. For example, matching the favorite food items against the first food item may comprise scoring the first food item against the favorite food items based on a name, a description, and an ingredient of the first food item.

The first merchant is communicated to the first user, at step 306. In addition to the first merchant, a plurality of merchants in proximity to the first user may be determined, wherein the plurality of merchants offer a plurality of food items corresponding to the first food preferences. The plurality of merchants may also be communicated to the first user.

A selection of the first merchant by the first user may be received. Thus, first merchant information for the first merchant may be accessed, wherein the merchant information comprises a first merchant location and first merchant menu information for the first food item. The first merchant location and the first merchant menu information may be communicated to the first user.

A second merchant in proximity to the first merchant may be determined, wherein the second merchant also offers the first food item corresponding to the first food preferences. The second merchant may be communicated to the first user. Additionally, user ratings of the first merchant and the second merchant offering the first food item may be accessed, wherein the user ratings comprise a food rating of the first item offered by the first merchant and the second merchant. The user ratings may further comprise a business satisfaction rating of the first merchant and the second merchant. The user ratings may be communicated to the first user.

In various embodiments, second food preferences for a second user associated with the first user may be accessed. The second user may comprise a user in proximity to the first user or a user associated with the first user, such as a friend, family member, significant other, etc. The first merchant in proximity to the first user may be further determined using the second food preferences.

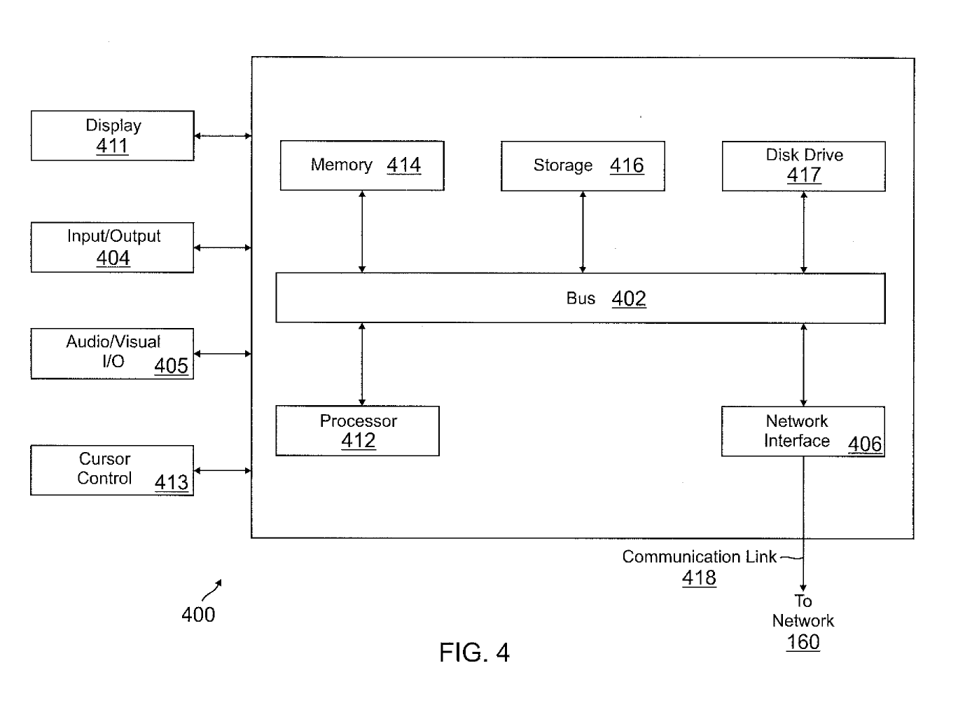

FIG. 4 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 160. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many foul's, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user information comprising first food preferences for a first user; and
one or more hardware processors in communication with the non-transitory memory and configured to:
access the first food preferences for the first user;
determine a first merchant in proximity to the first user, wherein the first merchant offers a first food item corresponding to the first food preferences; and
communicate the first merchant to the first user.

2. The system of claim 1, wherein the one or more hardware processors is further configured to:
determine a plurality of merchants in proximity to the first user, wherein the plurality of merchants offer a plurality of food items corresponding to the first food preferences;
communicate the plurality of merchants to the first user.

3. The system of claim 1, wherein the one or more hardware processors is further configured to:
receive a selection of the first merchant by the first user;
access first merchant information for the first merchant, wherein the merchant information comprises a first merchant location and first merchant menu information for the first food item; and
communicate the first merchant location and the first merchant menu information to the first user.

4. The system of claim 1, wherein the one or more hardware processors is further configured to:
determine a second merchant in proximity to the first user, wherein the second merchant offers the first food item corresponding to the first food preferences;
access user ratings of the first merchant and the second merchant offering the first food items, wherein the user ratings comprise a food rating of the first item offered by the first merchant and the second merchant; and
communicate the user ratings to the firs user.

5. The system of claim 4, wherein the user ratings further comprise a business satisfaction rating of the first merchant and the second merchant.

6. The system of claim 1, wherein the one or more hardware processor is further configured to:
access second food preferences for a second user associated with the first user,
wherein the first merchant in proximity to the first user is further determined using the second food preferences.

7. The system of claim 1, wherein the first food preferences comprise favorite food items, and wherein the first merchant is determined by matching the favorite food items against the first food item.

8. The system of claim 7, wherein the matching the favorite food items against the first food item comprises scoring the first food item against the favorite food items based on a name, a description, and an ingredient of the first food item.

9. A method comprising:
accessing first food preferences for a first user;
determining, using one or more hardware processors, a first merchant in proximity to the first user, wherein the first merchant offers a first food item corresponding to the first food preferences; and
communicating the first merchant to the first user.

10. The method of claim 9 further comprising:
determining a plurality of merchants in proximity to the first user, wherein the plurality of merchants offer a plurality of food items corresponding to the first food preferences;
communicating the plurality of merchants to the first user.

11. The method of claim 9 further comprising:
receiving a selection of the first merchant by the first user;
accessing first merchant information for the first merchant, wherein the merchant information comprises a first merchant location and first merchant menu information for the first food item; and
communicating the first merchant location and the first merchant menu information to the first user.

12. The method of claim 9 further comprising:
determining a second merchant in proximity to the first user, wherein the second merchant offers the first food item corresponding to the first food preferences;
accessing user ratings of the first merchant and the second merchant offering the first food items, wherein the user ratings comprise a food rating of the first item offered by the first merchant and the second merchant; and
communicating the user ratings to the firs user.

13. The method of claim 12, wherein the user ratings further comprise a business satisfaction rating of the first merchant and the second merchant.

14. The method of claim 9 further comprising:
accessing second food preferences for a second user associated with the first user,
wherein the first merchant in proximity to the first user is further determined using the second food preferences.

15. The method of claim 9, wherein the first food preferences comprise favorite food items, and wherein the first merchant is determined by matching the favorite food items against the first food item.

16. The method of claim 15, wherein the matching the favorite food items against the first food item comprises scoring the first food item against the favorite food items based on a name, a description, and an ingredient of the first food item.

17. A non-transitory computer readable medium comprising a plurality of machine-readable instructions which when executed by one or more processors of a server are adapted to cause the server to perform a method comprising:
accessing first food preferences for a first user;
determining a first merchant in proximity to the first user, wherein the first merchant offers a first food item corresponding to the first food preferences; and
communicating the first merchant to the first user.

18. The non-transitory computer readable medium of claim 17, wherein the method further comprises:
receiving a selection of the first merchant by the first user;
accessing first merchant information for the first merchant, wherein the merchant information comprises a first merchant location and first merchant menu information for the first food item; and
communicating the first merchant location and the first merchant menu information to the first user.

19. The non-transitory computer readable medium of claim 17, wherein the method further comprises:
determining a second merchant in proximity to the first user, wherein the second merchant offers the first food item corresponding to the first food preferences;
accessing user ratings of the first merchant and the second merchant offering the first food items, wherein the user ratings comprise a food rating of the first item offered by the first merchant and the second merchant; and
communicating the user ratings to the firs user.

20. The non-transitory computer readable medium of claim 17, wherein the method further comprises:
accessing second food preferences for a second user associated with the first user,
wherein the first merchant in proximity to the first user is further determined using the second food preferences.
